(19) United States
(12) Patent Application Publication
(10) Pub. No.: US 2002/0121948 A1
(43) Pub. Date: Sep. 5, 2002

(54) Circuit breaker comprising a current transformer with a partial air gap

(76) Inventors: Zoltan Giday, Neumuenster (DE); Alan J. Messerli, Bristol, CT (US)

Correspondence Address: CANTOR COLBURN, LLP, 55 GRIFFIN ROAD SOUTH, BLOOMFIELD, CT, 06002

(21) Appl. No.: 10/063,511

(22) Filed: May 1, 2002

Related U.S. Application Data
(62) Division of application No. 09/519,222, filed on Mar. 6, 2000.

(51) Int. Cl. H01H 73/00

(52) U.S. Cl. 335/18

(57) ABSTRACT

A circuit breaker assembly having an electronic trip unit used to detect an overcurrent condition in a protected electrical circuit. The electronic trip unit being electrically connected to a current transformer used to sense electrical current and provide operating power to the electronic trip unit. The current transformer comprising a metal core having a top surface and a bottom surface where the difference between the top and bottom surfaces defines a height of the core. The core having a concentrical opening extending through the height so that the distance between an outside point on the concentrical opening and the closest outside point of the core defines a thickness of the core at that point. Passing through the core opening is a primary winding and encircling the thickness of the core is a secondary winding. To optimize usage of the current transformer, a partial air gap is added to the metal core so that the range of operation is maximized while at the same time minimizing the remanence attenuation.

### CROSS REFERENCE TO RELATED APPLICATIONS

This Application is a divisional application of U.S. application Ser. No. 09/519,222 filed Mar. 6, 2000, which is hereby incorporated by reference in their entirety.

### BACKGROUND OF INVENTION

The present invention relates to current transformers and, more specifically, to current transformers for use in circuit breakers.

Conventional circuit breaker devices with electronic trip units typically include a current transformer disposed around a line conductor of a distribution system providing electrical power to a load. The current transformer has a multi-turn secondary winding electrically connected to the circuit breaker's electronic trip unit. The secondary winding is used to sense a current overload or imbalance in the aforesaid line conductors and, in response thereto, provide an output signal proportional to the current overload or imbalance to the trip unit. Upon receipt of such a signal the trip unit initiates an interruption of the current supplied to the load through the line conductors. The secondary winding may also be used to provide operating power to the electronic components within the circuit breaker's electronic trip unit.

Operationally, the load current in a circuit breaker can cover a very wide range. Unfortunately, the magnetic materials commonly available for the core of the current transformer limit the dynamic range of the sensing device. Peak flux density is a limiting factor at the upper end of the dynamic range, while core loss/declining permeability is a limit at the lower end. For a given core material and required accuracy, these parameters limit the operating range of the current transformer. While the dynamic range could be extended by increasing the volume of the core material and/or the turns of a secondary winding, these solutions increase the size of the current transformer, which is often critical.

Often, a toroidal current transformer having a core in the shape of a toroid is utilized. A continuous, toroidal core provides a desirable, full dynamic range. However, the use of this type of core in a current transformer for use with a trip unit is not ideal. A trip unit is required to power-up and trip on the first half cycle. Therefore, it is necessary for the current output by the current transformer to have a uniformsized first half cycle. In other words, it is necessary to employ a current transformer that outputs current with minimal attenuation. While a current transformer having a continuous, toroidal core would provide the desirable, full dynamic range of operating currents, such a current transformer would also provide an undesirable and significant remanence attenuation. Remanence is the flux density that remains in the core after the magnetizing force has ceased. Because of the significant remanence attenuation associated with a continuous, toroidal core, the use of a current transformer having such a core is less than ideal.

To reduce the level of remanence, an air gap can be added to the magnetic core by removing a section of the magnetic core, thus creating a “C” shaped core. When this is done, however, the air gap decreases the level at which saturation of the core takes place and thus reduces the range of current in which the current transformer can operate.

Another commonly used current transformer has a core made of stacked laminations. To prevent the core from becoming saturated at higher current levels, expensive magnetic steel laminates are used. These laminates are sized to allow short-circuit current sensing without causing the core to saturate. A current transformer having a stacked, laminated core transmits very little remanence attenuation, but their use is not ideal because they have a limited range of operation.

### SUMMARY OF INVENTION

In an exemplary embodiment of the invention, a current transformer used to sense electrical current and provide operating power to an electronic trip unit includes a metal core having a top surface and a bottom surface, where the difference between the top and bottom surfaces defines a height of the core. The core has a concentric opening extending through the height so that the planar distance between an outside point on the concentric opening and the closest outside point of the core defines a thickness of the core at that point. A primary winding passes through the opening. A secondary winding also extends through the opening and encircles the thickness of the core. A partial air gap is located in the metal core.

This construction has a number of advantages over the prior art. The use of the air gap reduces the attenuation while still maintaining a maximum operating range. The size of the partial air gap can be pre-determined to optimize the current transformer functionality by minimizing the remanence attenuation while at the same time maximizing the current operating range.

### BRIEF DESCRIPTION OF DRAWINGS

Referring now to the drawings wherein like elements are numbered alike in the several Figures:

FIG. 1 is a top perspective view of a circuit breaker comprising a partially gapped toroid core current transformer of the present invention;

FIG. 2 is a perspective view of a toroid core current transformer of the prior art;

FIG. 3 is a perspective view of a toroid core current transformer of the prior art;

FIG. 4 is a perspective view of a partially gapped toroid core current transformer of the present invention;

FIG. 5 is a top view of the partially gapped toroid core of FIG. 4;

FIG. 6 is a sectional view of the partially gapped toroid core taken along line 66 of FIG. 5;

FIG. 7 is a perspective view of a first alternative embodiment of a partially gapped toroid core of present invention;

FIG. 8 is a perspective view of a second alternative embodiment of a partially gapped toroid core of present invention;

FIG. 9 is a perspective view of a third alternative embodiment of a partially gapped toroid core of present invention;

FIG. 10 is a perspective view of a fourth alternative embodiment of a partially gapped toroid core of present invention; and

FIG. 11 is a perspective view of a fifth alternative embodiment of a partially gapped toroid core of present invention.

### DETAILED DESCRIPTION

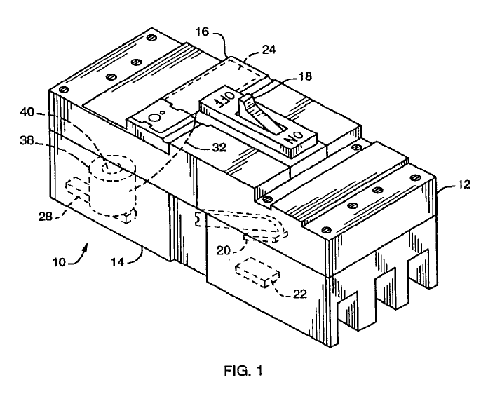

A circuit breaker 10 of the type consisting of a molded plastic cover 12 secured to a molded plastic case 14 is shown in FIG. 1. The circuit breaker 10 also comprises an accessory cover 16 and an externally-accessible operating handle 18 which manually controls the open and closed condition of a moveable contact 20 in relation to a fixed contact 22 via a circuit breaker operating mechanism (not shown). When opened, the contacts 20, 22 interrupt the current flow through an electronic trip unit 24 located within the circuit breaker cover 12.

Electrical current within the distribution circuit is sampled by a current transformer 38 arranged around a load strap 28 that forms a connection with an external electrical distribution circuit (not shown). An electronic trip unit 24, mounted beneath accessory cover 16, is arranged to receive the sampled current from the current transformer 38. When the sampled current indicates an overcurrent condition in the electrical distribution circuit, electronic trip unit 24 provides a trip signal to an electromechanical actuator (not shown). In response to the trip signal, the electromechanical actuator unlatches the circuit breaker operating mechanism. Once unlatched, the operating mechanism opens contacts 20 and 22, thus interrupting current flow through the electrical distribution circuit and protecting the distribution circuit from damage due to the overcurrent condition. Operation of the circuit breaker 10 is known in the art.

For ease of illustration, FIG. 1 shows one current transformer 38, however it is to be appreciated that in a multi-phase electrical distribution system there is one current transformer for each phase. The current transformer 38 provides both operating power as well as current sampling to the electronic trip unit 24.

FIG. 2 shows a current transformer 26 of the prior art. Conventionally, when a current transformer is needed to measure a load current having a very wide dynamic range, often a transformer 26 having a toroid core 30, as shown in FIG. 2, is utilized. The toroidal core 30 of the current transformer 26 is conventionally formed of tape wound magnetic steel. Desirable materials for transformer cores are those that have a high flux density and keep the temperature rise within desirable limits. Once the core is properly wound it is typically spot welded and coated with a finishing material to hold it together.

Referring to Prior Art FIG. 2, the core 30 of the current transformer 26 surrounds the load strap 28, which also serves as a primary winding, and encircling the core 30 is a secondary winding 32. The current transformer 26 having a core 30 being in the shape of a toroid is capable of operation when the load current covers a very wide dynamic range, however, the effects of remanence attenuation will be significant.

In an attempt to reduce the remanence attenuation, an air gap 39 as shown in Prior Art FIG. 3 is often added to the core 30 to form a gapped core 36. The material used to construct the core 30 has a Hysteresis or B-H loop which defines the flux density of the material, the coercive force, the amount of drive level required to saturate the core and the permeability. By adding an air gap 39 to the core 30 the B-H loop is sheared thereby lowering the flux and allowing tighter control of the remanence. Adding air gap 39 helps to reduce the amount of remanence attenuation however, the air gap 39 decreases the level at which saturation of the gapped core 36 takes place thereby reducing the range in which the current transformer 26 can operate.

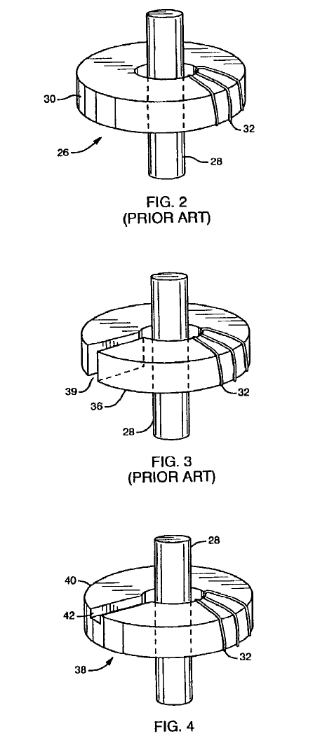

Referring to FIG. 4, a current transformer 38 of the present invention includes the load strap or primary winding 28 encircled by a partial gapped core 40 which is formed by adding a partial gap 42 in the core 30. Surrounding the partial gapped core 40 is the secondary winding 32. As in the prior art, the toroidal core 40 of the present invention is conventionally formed of tape wound magnetic steel, with desirable materials for transformer cores including those materials that have a high flux density and keep the temperature rise within desirable limits. Once the core 40 is properly wound, it is spot welded and coated with a finishing material.

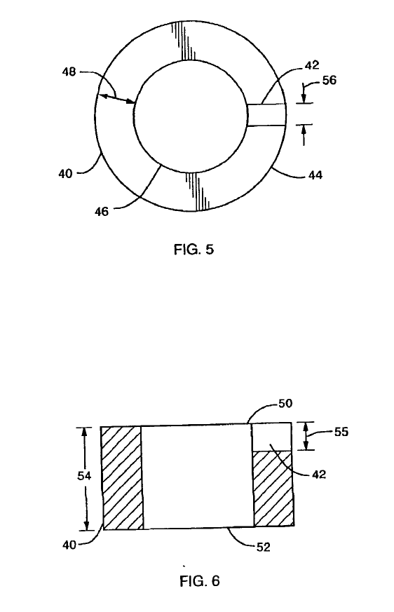

Referring to FIGS. 5 and 6, the partially gapped core 40 comprises an outside diameter 44 and an inside diameter 46 where ½ the difference between the outside diameter 44 and the inside diameter 46 defines a partially gapped core 40 thickness 48. Additionally, the partially gapped core 40 comprises the top surface 50 and a bottom surface 52 where the difference between the two defines a height 54 of the partially gapped core 40. A width 56 of the partial air gap 42 is defined as the opening in the thickness 48 of the core 40.

The size of the partial air gap 42 would vary depending on the desired optimization of the current transformer 38. If the primary consideration of the current transformer is the range in which it can operate, then a smaller partial air gap 42 might be used. However, if reducing the remanence attenuation is the major consideration, a larger partial air gap 42 might be utilized. In the embodiment shown, the partial air gap 42 extends through the entire thickness 48 of the core 40 and has a width 56 of approximately 0.010 inch and a height 55 of approximately ¾ of the height 54. Preferably, width 56 is in the range of 0.010 to 0.020 inches and height 55 is between 1/3 to ¾ of the height 54. Width 56 and height 55 can be varied depending on the desired application of the current transformer 38.

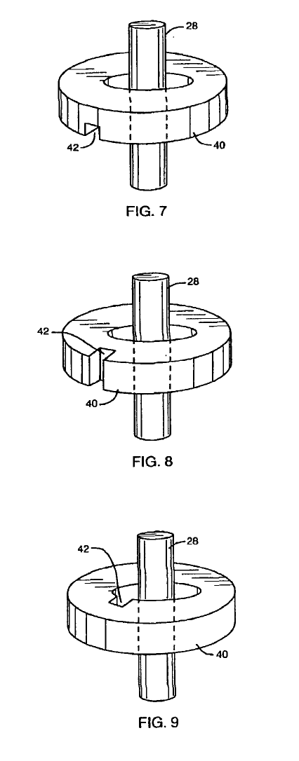

FIGS. 4-6 depict the partial gapped core 40 as a toroid type core with the partial air gap 42 oriented in on a top surface 50 of the partially gapped core 40. It is to be appreciated that other core types can be utilized and the partial air gap 42 can be oriented differently on the partially gapped core 40, some examples of possible orientation of the partial air gap 42 are shown in FIGS. 7-11.

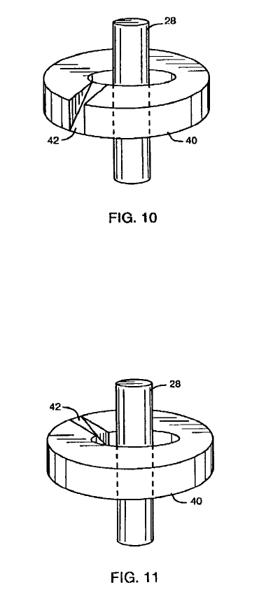

FIG. 7 shows the partial air gap 42 oriented on the bottom surface 52 of the partially gapped core 40 extending through the entire thickness 48 of the core 40 and partially through the height 54 of the core 40. FIG. 8 shows the partial air gap 42 oriented on the outside diameter 44 of the core 40 extending through the entire height 54 of the core 40 and partially through the thickness 48 of the core 40. FIG. 9 shows the partial air gap 42 oriented on the inside diameter 46 of the core 40 extending through the entire height 54 of the core 40 and partially through the thickness 48 of the core 40. FIG. 10 shows the partial air gap 42 angled through the core 40 originating at a point on the inside diameter of the top surface and terminating at a point on the outside diameter of the bottom surface. Finally, FIG. 11 shows the partial air gap 42 angles through the core 40 originating at a point on the outside diameter of the top surface and terminating at a point on the inside diameter of the bottom surface.

By utilizing a partial gapped core 40 the current transformer 38 optimizes both the operational dynamic range of the load current and the remanence attenuation. That is the operational dynamic range of the load current is maximized while at the same time minimizing the amount of remanence attenuation. The partial air gap 42 keeps a portion of the core 40 from magnetizing thereby minimizing the effects of remanence. The range is a function of the cross section area, a complete air gap 34 as shown in FIG. 3 puts a high magnetic impedance path in the core 36 and causes the current transformer 26 to saturate at a lower level. Wherein a partial air gap 42 puts some impedance in but the impedance is small enough to not cause a significant lowering of the saturation level.

It will be understood that a person skilled in the art may make modifications to the preferred embodiment shown herein within the scope and intent of the claims. While the present invention has been described as carried out in a specific embodiment thereof, it is not intended to be limited thereby but is intended to cover the invention broadly within the scope and spirit of the claims.

What is claimed is:

1. A current sensor for sensing a current in a conductor, comprising:
a toroidal transformer core encircling said conductor;
a secondary winding passing through the toroidal transformer core at least once such that a voltage signal is generated in said secondary winding that is indicative of a current in said conductor;
a sensing circuit electrically connected to said secondary winding for receiving said voltage signal and generating a response that depends upon the magnitude of said voltage signal; and
wherein said core includes a partial air gap comprising a portion of reduced circumferential cross-section area.

2. The current sensor of claim 1 wherein said partial air gap is configured to reduce the remanence attenuation of said toroidal transformer core without reducing the operating range of the current sensor below a selected minimum.

3. The current sensor of claim 1 wherein said partial air gap has a thickness between approximately 0.010 inches and approximately 0.020 inches.

4. The current sensor of claim 3 wherein said partial air gap has a thickness of approximately 0.010 inches.

5. The current sensor of claim 1 wherein said circumferential cross section area of said toroidal transformer core at said partial air gap is reduced by approximately ⅓ to approximately ¾.

6. The current sensor of claim 5 wherein said circumferential cross section area of said toroidal transformer core at said partial air gap is reduced by approximately ¾.

7. A current sensor for sensing a current in a conductor, comprising:
transformer for generating a signal indicative of a current in said conductor, said transformer comprising a toroidal core;
means for optimizing the operational dynamic range of the load current and the remanence attenuation; and means for processing said signal.

8. The current sensor of claim 7 wherein:
said means for optimizing the operational dynamic range of the load current and the remanence attenuation includes a partial air gap in said core.

9. The current sensor of claim 8 wherein said means for processing includes a trip unit configured to trip a circuit breaker when said signal indicates a fault condition.
